(19) United States
(12) Patent Application Publication
(10) Pub. No.: US 2008/0256154 A1
(43) Pub. Date: Oct. 16, 2008

(54) Method and Apparatus for Synthesizing a User Defined Pre-Emphasized Arbitrary Waveform for High Speed Serial Data Technologies

(75) Inventor: Ramachandra C.V., Bangalore (IN)

Correspondence Address: WILLIAM K. BUCHER;TEKTRONIX, INC., 14150 S.W. KARL BRAUN DRIVE, P.O. BOX 500, MS 50-LAW, BEAVERTON, OR, 97077, US

(73) Assignee: TEKTRONIX INTERNATIONAL SALES GMBH, Rheinfall (CH)

(21) Appl. No.: 12/111,173

(22) Filed: Apr. 28, 2008

(30) Foreign Application Priority Data
Apr. 16, 2007 (IN) 742/MUM/2007

(51) Int. Cl. G06F 1/02; G06F 17/13; G06F 17/10

(52) U.S. Cl. 708/271; 708/443; 708/420

(57) ABSTRACT

The embodiments herein provide a device and method to generate Pre-emphasized signal. In one embodiment herein an input file containing digital data representing a digital data pattern waveform is received and up-sampled by an Fs/Fd rate. The up-sampled digital data is used for generating step response. The generated step response is differentiated to generate coefficients of a pre-emphasis filter which are convolved with the digital data pattern waveform input signal to generate a pre-emphasized digital data pattern waveform file.

### BACKGROUND OF THE INVENTION

The present invention relates generally to high-speed serial data technology and more particularly to the generation of waveforms for transmission on high-speed data technologies.

The driving need for better system performance and higher clock speeds has led to a greater challenge for designers. Wide-bandwidth data transfer over long transmission traces or lines, such as backplane connections in a cabinet and cable connections between cabinets, are required to realize high performance systems and appliances. Increases in the transmission speed and trace length of transmission lines further leads to increases in the signal path (channel) effects.

These effects caused during signal transmission are similar to a low pass filter that decreases the gain of the high frequency signal. The reasons behind such effects may be dielectric loss and skin effect, although crosstalk and stub reflections caused by poor termination may also cause problems.

Further, both dielectric loss and skin effect may cause problems of Inter-Symbol-Interference (ISI), because the attenuation of the signal prevents it reaching the full strength within its symbol time, causing it to spread into the next signal.

The ISI effect is pattern dependent and is known as “Pattern Dependent Jitter” (PDJ) or Data Dependent Jitter (DDJ). If a string of data remains at the same level, for example: “000000”, then the energy in the signal has the time to reach its peak and hence will be transmitted correctly; however, for a high transition density signal such as “1010101”, the full signal strength is not reached within the symbol time causing spread. The “PDJ” causes smearing of the eye diagram, signal rounding and time displacement.

A further complication is caused by channel dispersion, where the losses in the medium cause different frequency components of the signal to have different delays as they travel along the transmission line. This further reduces signal amplitude, and adds residual error from previous bits, leading to an increase in inter symbol interference. The effect of distortions may be seen in FIGS. 1a, 1b, 2a and 2b. FIG. 1a represents a Serial ATA signal at a transmitter and FIG. 1b represents the corresponding eye diagram of the Serial ATA signal at the transmitter. FIG. 2a represents the Serial ATA signal at a receiver without the use of pre-emphasis in the transmitter and FIG. 2b represents the corresponding eye diagram of the Serial ATA signal at a receiver without the use of pre-emphasis in the transmitter.

An available solution for overcoming such signal distortions is pre-emphasizing the waveform. Pre-emphasis boosts the high frequency components of the signal by amplifying the high frequency components using active circuitry. Conversely, De-emphasis decreases the low frequency components by filtering the low frequency components using passive circuitry. Both pre-emphasizing and de-emphasizing a signal compensates for inter symbol interference. One available solution for providing a pre-emphasized signal is shown in FIG. 3a. As shown, a data generator 303, such as the DTG500 Series of Digital Timing Generators, manufactured and sold by Tektronix, Inc., and the like, provides the signal waveform 307 and an inverse of the signal waveform 309. The signal waveform 307 and the inverse signal waveform 309 are provided to a power combiner 305. The power combiner 305 delay the inverted signal waveform 309 and combines the signal waveform 307 with the inverted-delayed signal waveform to provide a pre-emphasized signal to a device under test 311.

FIG. 3b shows a functional block diagram of the working of power combiner 305. The signal waveform 307 is split with the signal waveform 307 being applied to a summing node 315 and to an inverter 317 in the form of the box labeled Z⁻¹. The output of the inverter 317 is applied to a delay circuit 319 having a programmable amplitude control for providing an amplification factor to the inverted waveform signal 309. The inverted-delayed waveform signal is applied to the summing node 315 where it is combined with the waveform signal 307 to provide the pre-emphasized signal.

However, the above solution requires a power combiner 305 and two signal outputs 307 and 309 from a signal generator. This makes the setup more complex and hence takes more time to complete the desired pre-emphasizes signal generation. The above solution may introduce unexpected distortions, such as reflections and impedance mismatches, in the pre-emphasized signal output that are due to cable interconnects and the external power combiner 305. Further, the data generator 303 and power combiner 305 solution requires calibration before any signal waveform output is made. Also, the total cost of the solution increases due to the extra cable and power combiner.

There is therefore a requirement of a signal synthesizer for producing user defined pre-emphasized arbitrary waveforms, which may be easily implemented in the data generator.

### SUMMARY OF THE INVENTION

The present invention is an apparatus and method for synthesizing a user defined data pattern waveform file having pre-emphasis. The method for synthesizing a user defined data pattern waveform file having pre-emphasis has the step of receiving digital data from an input file representing a data pattern waveform having a bit duration defined by a user selected data rate Fd. A subsequent step up-samples the digital data by an Fs/Fd rate where a user selects sampling frequency Fs of the digital data. The method has further steps of generating a step response from the up-sampled digital data, differentiating the step response to generate coefficients of a pre-emphasis filter, and convolving the coefficients of the pre-emphasis filter with the digital data of the input file to generate a data pattern waveform file having pre-emphasis. An additional step is generating an analog pre-emphasized waveform signal corresponding to the synthesized pre-emphasized data pattern waveform.

The step of generating the step response includes an initial step of generating and normalizing an exponential decaying signal “X” data array having a time duration “t”=A*(1/Fd) where “A” is a fraction of the bit duration of the data pattern waveform. A first waveform “X1” data array is generated from the normalized exponential decaying signal array using an equation in the form of X1=X*α, where α is a user selected pre-emphasis level. The resulting waveform “X1” data array is then inverted. A second waveform “X3” data array is generated from the normalized exponential decaying signal data array using an equation in the form of X3=1+X*(α−1). A third waveform “X2” data array is generated using the last element of waveform data array “X1” having a time duration t1=(1−A)*(1/Fd). The resulting waveform data arrays “X1”, “X2” and “X3” are concatenated to form the step response. The fraction of the bit duration “A” of the data pattern waveform may be selected from a range of 0<A<1.

The apparatus for synthesizing a user defined data pattern waveform file having pre-emphasis has a synthesizer that includes means for receiving digital data from an input file representing a data pattern waveform having a bit duration defined by a user selected data rate Fd. The digital data is up-sampled by an Fs/Fd rate using a means for up-sampling where a user selects sampling frequency Fs of the digital data. The synthesizer further has a means for generating a step response from the up sampled digital data, means for differentiating the step response to generate coefficients of a pre-emphasis filter, and means for convolving the coefficients of the pre-emphasis filter with the digital data of the input file to generate a data pattern waveform file having pre-emphasis. The apparatus has a waveform generating means for generating an analog pre-emphasized waveform signal corresponding to the synthesized pre-emphasized data pattern waveform.

The synthesizer additionally has a means for generating and normalizing an exponential decaying signal “X” data array having a time duration “t”=A*(1/Fd) where “A” is a fraction of the bit duration of the data pattern waveform. The synthesizer has means for generating a first waveform “X1” data array and a second waveform “X3” data array from the normalized exponential decaying signal array using an equation in the form of X1=X*α for the first waveform “X1” data array and X3=1+X*(α−1). for the second waveform data array where α is a user selected pre-emphasis level. A means for inverting the first waveform “X1” data array is provided along with a means for generating a third waveform data array “X2” using the last element of the first waveform data array “X1” having a time duration t1=(1−A)*(1/Fd). A means for concatenating the waveform data arrays “X1”, “X2” and “X3” provides the step response. The fraction of the bit duration “A” of the data pattern waveform may be selected from a range of 0<A<1

The objects, advantages and novel features of the present invention are apparent from the following detailed description when read in conjunction with appended claims and attached drawings.

### BRIEF DESCRIPTION OF THE DRAWING FIGURES

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1a shows a signal at a transmitter without pre-emphasis.

FIG. 1b shows the eye diagram corresponding to the signal at the transmitter without pre-emphasis.

FIG. 2a shows a signal without pre-emphasis at a receiver.

FIG. 2b shows the eye diagram of the signal without pre-emphasis at the receiver.

FIG. 3a shows a setup for pre-emphasizing a waveform signal as available in the prior art.

FIG. 3b shows a functional block diagram of a power combiner in the setup for pre-emphasizing a waveform signal as per the prior art.

FIG. 4 shows a waveform generator for providing a pre-emphasized signal according to an embodiment of the present invention.

FIG. 5 shows a method of synthesizing a pre-emphasized waveform signal according to an embodiment of the present invention

FIG. 6a shows a waveform signal at the transmitter when the pre-emphasis is performed according to one embodiment of the present invention.

FIG. 6b shows the eye diagram of the waveform signal at the transmitter when the pre-emphasis is performed according to one embodiment of the present invention.

FIG. 7a shows the waveform signal at the receiver when the pre-emphasis is performed according to one embodiment of the present invention.

FIG. 7a shows the eye diagram of the waveform signal at the receiver when the pre-emphasis is performed according to one embodiment of the present invention.

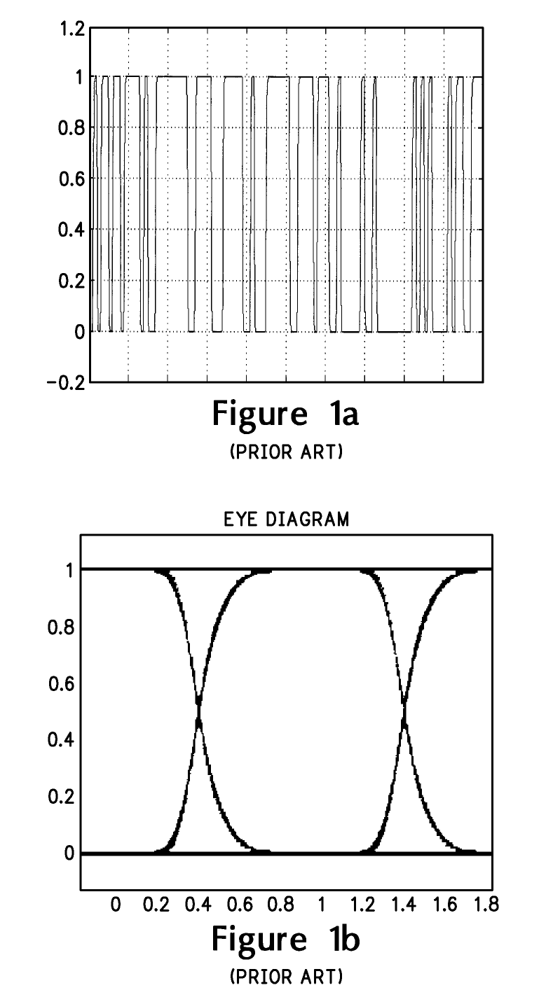

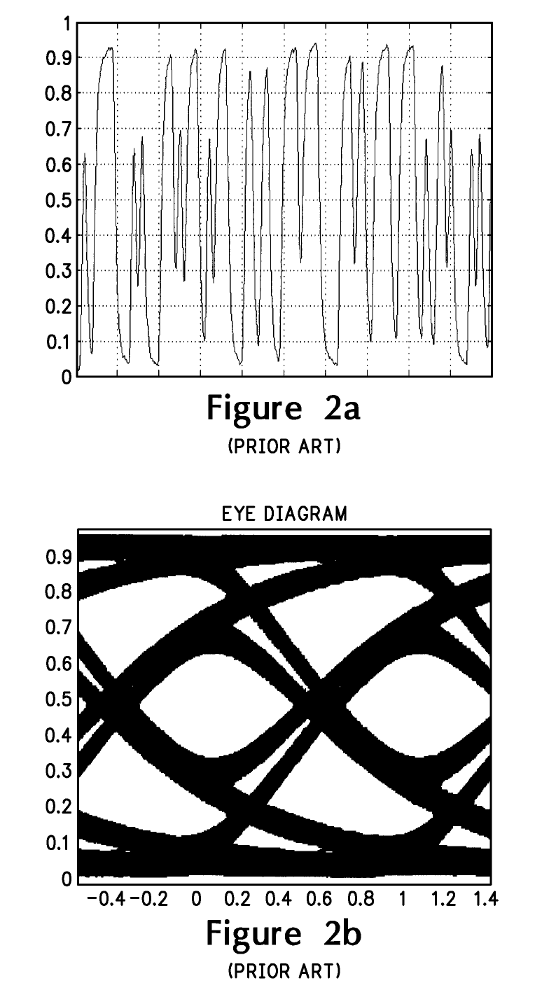

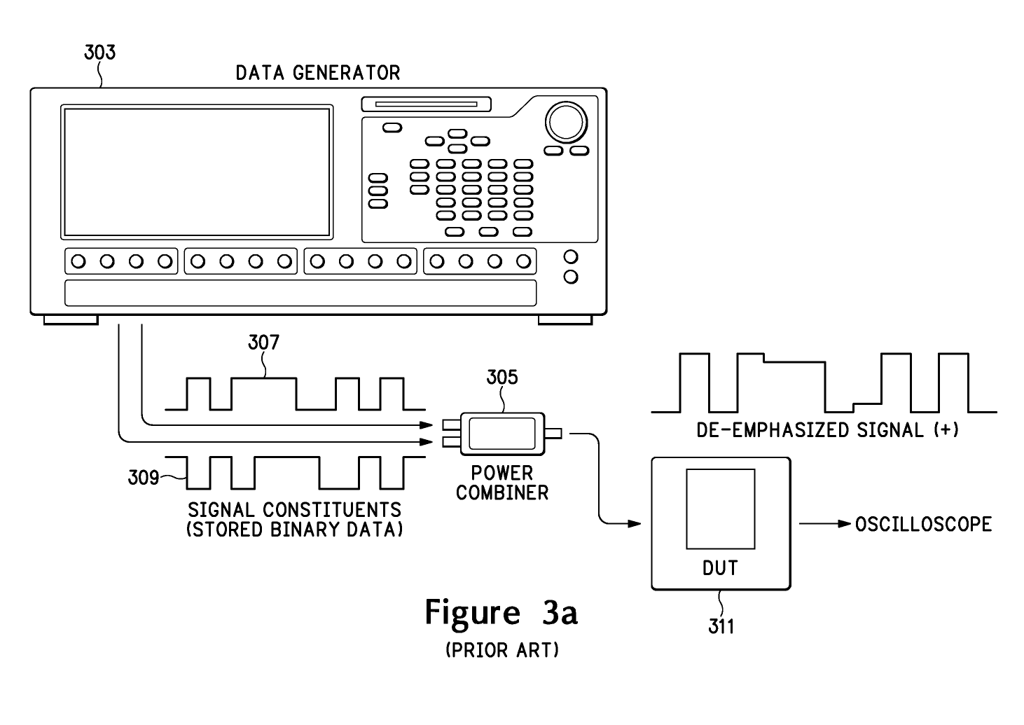

### DESCRIPTION OF THE INVENTION

The embodiments herein provide a device and method to generate a pre-emphasized signal. The embodiments provided herein reduce distortions in the signal. Further, the embodiments allow remodeling of the pre-emphasized signal as per the requirement. Further the embodiments may be easily implemented in various waveform generators. In one embodiment herein, an implementation in a personal computer is made available.

The invention described herein is explained using specific exemplary details for better understanding. However, the invention disclosed can be worked on by a person skilled in the art without the use of these specific details. The invention can be implemented into multiple types of waveform generators. The invention is intended to be implemented as software code. Structures and devices shown in block diagram are illustrative of exemplary embodiments of the invention and are meant to avoid obscuring the invention. Also, the connections between various elements may not necessarily be direct and the data transfer in between can be subjected to encoding, re-formatting or modifications.

References in the specification to “one embodiment” or “an embodiment” means that a particular feature, structure, characteristic, or function described in connection with the embodiment is included in at lest one embodiment of the invention. The appearances of the phrase “in one embodiment” in various places in the specification are not necessarily all referring to the same embodiment.

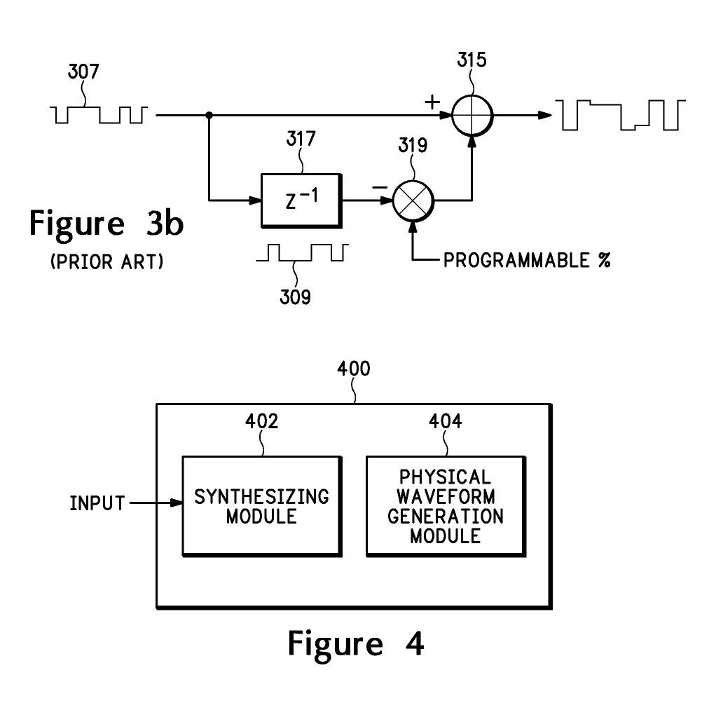

FIG. 4, shows a general block of a waveform generator 400 according to an embodiment of the present invention. The waveform generator 400, such as the AWG700 Series Arbitrary Waveform Generators, has a synthesizing module 402 in the form of algorithms stored in the waveform generator 400. The waveform generator 400 generally receives digital data in form of a previously stored input file defining a digital data pattern.

The synthesizing module 402 provides a synthesized signal which is then converted to file formats like *.wfm (Tektronix™ AWG Waveform Data Point File). The digital waveform data file (.wfm) is stored in the waveform generator 400 and provided to a waveform generation module 404. The waveform generation module 404 receives the digital waveform data and generates an analog signal output corresponding to the digital data pattern of the input file.

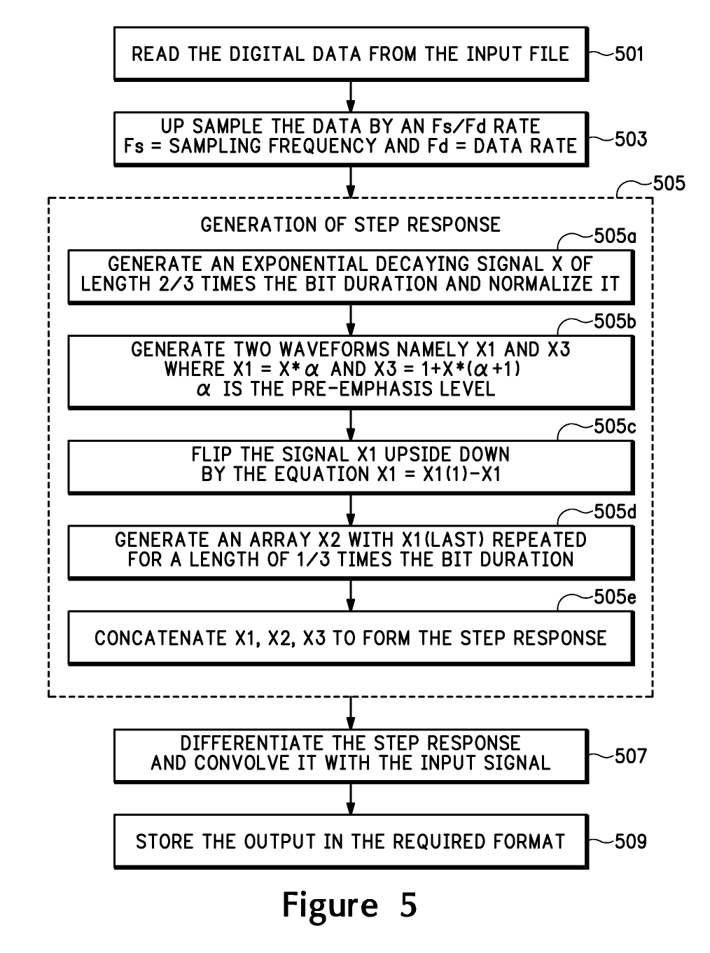

FIG. 5 shows a method of synthesizing a waveform, which may be further used to create the pre-emphasized waveform according to an embodiment of the present invention. The method of synthesizing a waveform takes as inputs a digital data input file and user defined sampling frequency (Fs), Data rate (Fd) and a pre-emphasis level.

The method comprises the steps of reading 501 the digital data from the input file. The input file contains the digital data representing a digital data pattern waveform, which needs to be pre-emphasized. The digital data from the input file is up-sampled by an Fs/Fd rate equal to ratio of sampling frequency (Fs) and Data rate (Fd) as represented in step 503. The up-sampled digital data from the input file is used as input data for the generation of a step response as represented by the step 505.

The generation of the step response step 505 includes generating an exponential decaying signal X data array of time duration t=⅔*(1/Datarate) which is a length ⅔ times the bit duration and normalizing the decaying signal X data array as represented in step 505a. The Matlab function chi2pdf(X, V) is used to compute the values of the exponential decaying signal X. Two waveform X1 and X3 data arrays are generated at step 505b where the waveform X1 data array is generated according to the equation X1=X*α where X is the normalized exponential decaying signal X data array and α is the pre-emphasis level or value in dBs. The waveform X3 data array is generated according to the equation X3=1+X*(α−1) where X is the normalized exponential decaying signal X data array and α is the pre-emphasis level or value in dBs. At step 505c, the waveform X1 data array is inverted or flipped upside down using the equation X1=X1(1)−X1 where X1(1) is the first element of the waveform X1 data array.

The last element of the waveform X1 data array is repeated for a time period t=⅓*(1/Datarate) which is the length of ⅓ times the bit duration to generate a waveform X2 data array as represented by step 505d. The step response is generated by concatenating the waveforms data arrays X1, X2, X3 as represented by step 505e.

The step response is differentiated to generate coefficients of a pre-emphasis filter which are convolved with the digital data of the input file during compiling as represented by step 507. The compiled digital data of the input file with pre-emphasis is stored as a data pattern waveform file (.wfm) as represented by step 509.

The ⅔ percentage value for the time duration for the generation of the exponential decaying signal X data array is by example only and other time duration percentage values may be used. For example, if the time duration of X is ¼*(1/Datarate), then the time durations of the waveform X1 and X3 data arrays will have a time duration of ¼ times the bit duration. The time duration of the waveform X2 data array will then be 1−¼=¾ or. 0.75 time the bit duration.

The stored digitized pre-emphasized waveform data is provided to the waveform generation module 404 that converts the digital pre-emphasized waveform data to a corresponding pre-emphasized analog signal output

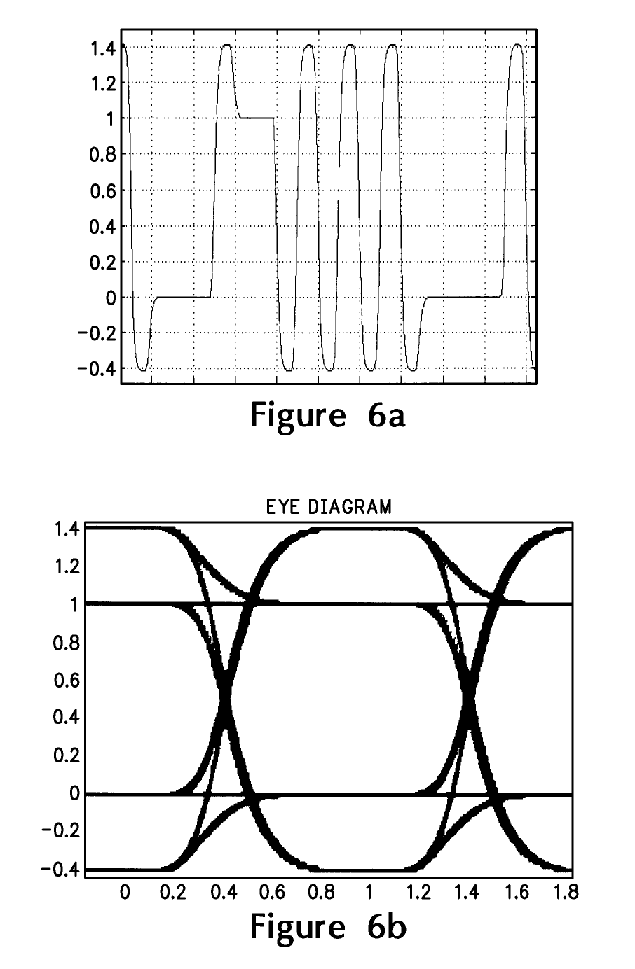

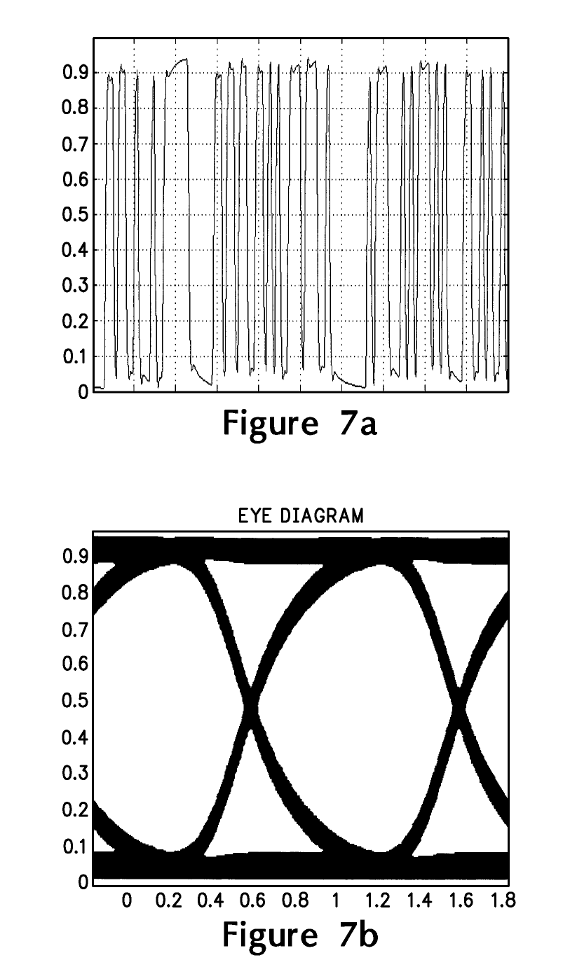

The embodiments of the invention provided allows generation of pre-emphasized signals, which compensates for cable losses and channel dispersion effects. The effects of pre-emphasis provided by the present invention according to the embodiment herein are shown in the Serial ATA signal of FIG. 6a at the transmitter end where the transition edges are boosted so as to compensate for high frequency losses in the channel. The corresponding eye diagram is shown at the transmitter end in FIG. 6b. The pre-emphasized Serial ATA signal at the receiver is shown in FIG. 7a and the corresponding eye diagram of the received pre-emphasized signal is shown in FIG. 7b. As clearly seen by the eye diagram of FIG. 7b, adding pre-emphasis to the Serial ATA signal at the transmitter minimizes inter symbol interference and channel dispersion effects in the output signal.

The foregoing description of the invention has been described for purposes of clarity and understanding. It is not intended to limit the invention to the precise form disclosed.

What is claimed is:

1. A method of synthesizing digitized pre-emphasized waveform data comprising the steps of:
a) receiving digital data from an input file representing a data pattern waveform having a bit duration defined by a user selected data rate Fd;
b) up-sampling the digital data by a Fs/Fd rate where Fs is a user selected sampling frequency of the digital data and Fd is the user selected data rate of the digital data;
c) generating a step response from the up sampled digital data;
d) differentiating the step response to generate coefficients of a pre-emphasis filter; and
e) convolving the coefficients of the pre-emphasis filter with the digital data of the input file to generate a data pattern waveform file having pre-emphasis.

2. The method of synthesizing digitized pre-emphasized waveform data as recited in claim 1 wherein the step response generating step further comprises the steps of:
a) generating and normalizing an exponential decaying signal “X” data array having a time duration “t”=A*(1/Fd) where “A” is a fraction of the bit duration of the data pattern waveform;
b) generating a first waveform “X1” data array from the normalized exponential decaying signal “X” data array using an equation in the form of X1=X*α, where α is a user selected pre-emphasis level;
c) generating a second waveform “X3” data array from the normalized exponential decaying signal “X” data array using an equation in the form of X3=1+X*(α−1)
d) inverting the waveform “X1” data array;
e) generating a third waveform “X2” data array using the last element of waveform “X1” data array having a time duration t1=(1−A)*(1/Fd); and
f) concatenating waveform data arrays “X1”, “X2” and “X3” to form the step response.

3. The method of synthesizing digitized pre-emphasized waveform data as recited in claim 2 further comprising the step of selecting the fraction of the bit duration “A” of the data pattern waveform in a range of 0<A<1.

4. The method of synthesizing digitized pre-emphasized waveform data as recited in claim 1 further comprising the step of generating an analog signal from the data pattern waveform file having pre-emphasis.

5. An apparatus synthesizing digitized pre-emphasized waveform data comprising:
means for receiving digital data from an input file representing a data pattern waveform having a bit duration defined by a user selected data rate Fd;
means for up-sampling the digital data by a Fs/Fd rate where Fs is a user selected sampling frequency of the digital data and Fd is the user selected data rate of the digital data;
means for generating a step response from the up sampled digital data;
means for differentiating the step response to generate coefficients of a pre-emphasis filter; and
means for convolving the coefficients of the pre-emphasis filter with the digital data of the input file to generate a data pattern waveform file having pre-emphasis.

6. The apparatus synthesizing digitized pre-emphasized waveform data as recited in claim 5 further comprising:
a) means for generating and normalizing an exponential decaying signal “X” data array having a time duration “t”=A*(1/Fd) where “A” is a fraction of the bit duration of the data pattern waveform;
b) means for generating a first waveform “X1” data array from the normalized exponential decaying signal “X” data array using an equation in the form of X1=X*α, where α is a user selected pre-emphasis level;
c) means for generating a second waveform “X3” data array from the normalized exponential decaying signal array using an equation in the form of X3=1+X*(α−1)
d) means for inverting the waveform “X1” data array;
e) means for generating a third waveform “X2” data array using the last element of waveform “X1” data array having a time duration t1=(1−A)*(1/Fd); and
f) means for concatenating waveform data array “X!”, “X2” and “X3” to form the step response.

7. The apparatus synthesizing digitized pre-emphasized waveform data as recited in claim 6 further comprising means for selecting the fraction of the bit duration of the data pattern waveform “A” in a range of 0<A<1.

8. The apparatus synthesizing digitized pre-emphasized waveform data as recited in claim 5 further comprising means for generating an analog signal from the data pattern waveform file having pre-emphasis.
